(19) United States
(12) Patent Application Publication
(10) Pub. No.: US 2003/0187717 A1
(43) Pub. Date: Oct. 2, 2003

(54) Method for marketing strategy optimization

(76) Inventors: Robert Crites, Hummelstown, PA (US); Yuchun Lee, Sudbury, MA (US); Andre Black, Boston, MA (US); Ramprasad Badvelu, Lowell, MA (US); Shiao-Bin Soong, Littleton, MA (US); John Wells, Weston, MA (US); Julie Chapman, Billerica, MA (US)

Correspondence Address: FISH & RICHARDSON PC, 225 FRANKLIN ST, BOSTON, MA, 02110, US

(21) Appl. No.: 10/113,779

(22) Filed: Mar. 29, 2002

(51) Int. Cl. G06F 17/60

(52) U.S. Cl. 705/10

(57) ABSTRACT

Marketing strategy optimization includes organizing a marketing strategy by plans and programs with each of plans and programs having input metrics having a causal relationship to output measurements that describe the outcome of the strategy. Optimization includes determining input measurements that optimize a given output for the strategy. Also described are graphical user interfaces for the optimization view that depicts a hierarchical organization of plans and programs associated with the market strategy, a region having target roll up values that are calculated by a marketing strategy optimization and a region having edit window to enter values for metrics associated with the plans and programs.

### BACKGROUND

This invention relates to marketing strategy optimization.

Organizations that desire to conduct multiple marketing campaigns or programs can benefit from strategic planning. Resources of various types including money and people need to be assigned to each of the campaigns in order for them to be timely and successful. Objectives can be defined for the marketing campaigns, and successful execution of the campaigns can be determined by measuring outcomes against these objectives. Lessons learned from these measurements can be applied to future strategic planning.

### SUMMARY

According to an aspect of the present invention, a method of marketing strategy optimization includes specifying a causal relationship between input measurements describing a marketing strategy and output measurements describing the outcome of the strategy, and determining input measurements that optimize a given objective

According to an aspect of the present invention, a method of marketing strategy optimization includes hierarchically organizing a marketing strategy by plans and programs with each of plans and programs having input metrics having a causal relationship to output measurements that describe the outcome of the strategy and determining input measurements that optimize a given output for the strategy.

According to an aspect of the present invention, a graphical user interface for an optimization view in a market strategy optimization program includes a first region which depicts a hierarchical organization of plans and programs associated with the market strategy, a second region having target roll up values in a column that are calculated by a marketing strategy optimization software and a third region having edit window to enter values for metrics when the hierarchy of plans and programs is expanded to show metrics associated with tile plans and programs.

One or more aspects of the present invention may provide one or more of the following advantages.

The invention provides a framework for defining marketing strategies in a hierarchical manner, including both the activities to be performed and the resources required. It allows objectives and other metrics to be defined to characterize the design of marketing strategies and their outcome. The invention applies sensitivity analysis and optimization algorithms to select a marketing strategy that best meets the desired objectives. It also provides tools allowing a user to collaborate in the optimization process, focusing the optimization with human expertise or facilitating “what-if” type scenarios. The invention allows filtering and ordering of potential solutions. The invention can deal with cases where the relationship between the parameters of a marketing strategy and its results are not fully known and must be specified probabilistically.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a computer system with marketing strategy optimization software.

FIG. 2 is a flow chart that depicts marketing strategy optimization.

FIG. 3 is a flow chart that depicts a process for defining a marketing plan.

FIG. 4 is a flow chart that depicts a process to define casual relationships among inputs, outputs, and objectives of a plan hierarchy.

FIG. 5 is a flow chart that depicts marketing strategy software optimized view.

FIGS. 6A-6H are diagrams that depict a graphical user interface.

### DETAILED DESCRIPTION

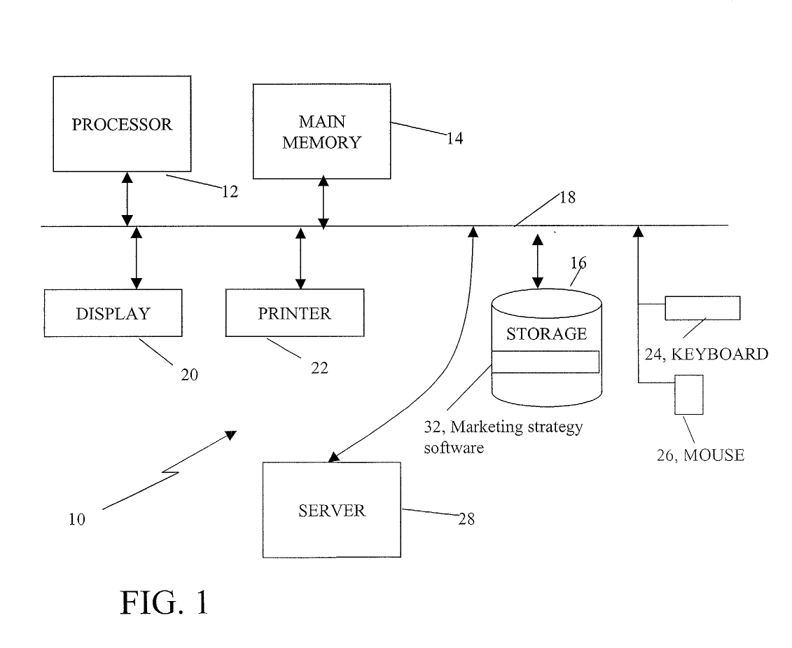

Referring now to FIG. 1, a computer system 10 includes a CPU 12, main memory 14 and persistent storage device 16 all coupled via a computer bus 18. The system 10 also includes output devices such as a display 20 and a printer 22, as well as user-input devices such as a keyboard 24 and a mouse 26. Not shown in FIG. 1 but necessarily included in a system of FIG. 1 are software drivers and hardware interfaces to couple all the aforementioned elements to the CPU 12.

The computer system 10 also includes marketing strategy software 32. The marketing strategy software 32 may reside on the computer system 10, as shown, or may reside on a server 28 that is coupled to the computer system 10 in a conventional client-server arrangement. The details on how this software 32 is coupled to this computer system 10 are not important to understand the present invention.

The marketing strategy software 32 organizes an organization's marketing activities using a hierarchy. At the top of the hierarchy is a Plan. A plan includes one or more programs. All metrics, such as ROI and financial analysis, are rolled up to the plan level. Therefore, all marketing initiatives that are analyzed together need to be components of the same plan. At the plan level, initial budgets are assigned and managers determine which metrics are tracked. An example might be that at the top-level plan can be a “fiscal year 2002 marketing plan.” The marketing strategy software 32 rolls up information and sends it through up to the plan level. Reports can be generated that show information cross multiple plans. Other examples of a plan might be “United States marketing” versus “European marketing”, or a division of a company versus a different division, or product lines or brands.

Programs provide an organizational substructure within a plan. A plan will typically have many programs. Programs include any number of activities. Also, multiple programs can be grouped together as a “program group”. These programs can span all channels and media including advertising, brand management, direct mail, email, web, events, and web-based seminars. Programs may be distinguished by particular geographical areas (e.g. the Midwest), or by function (e.g. customer acquisition), or according to other criteria. Programs also have resources and budgets assigned to them, and include a tangible start and end date. An example of program group might be “spring acquisition programs.” Beneath that type of program group could be specific programs that are email acquisition programs, direct mail acquisition programs, mass media acquisition programs. Under that program group may be actual programs like securing a particular slot for advertising on TV.

Programs have many activities. Each activity has a due date, and one or more individuals assigned to it. Activities are things that must be completed to execute a program. Activities in that program would be get pricing for the slot, determination duration of the slot, e.g., a 30 second slot or a 45 second slot, produce a story board of what that add will say, contract the agency, hire actors, and so forth.

A typical marketing program probably has anywhere from 100 to 300 activities depending on the level of detail that a user wants to track. Activities can be a task type of activity and a trigger type of activity. A Task is at the most granular levels. An activity can have one or more tasks, which can be thought of as lists of things to do. Tasks are either complete or not complete. The task types are activities that require actions to be performed whereas triggers are used to initiate other programs. A user can assign metrics to an activity.

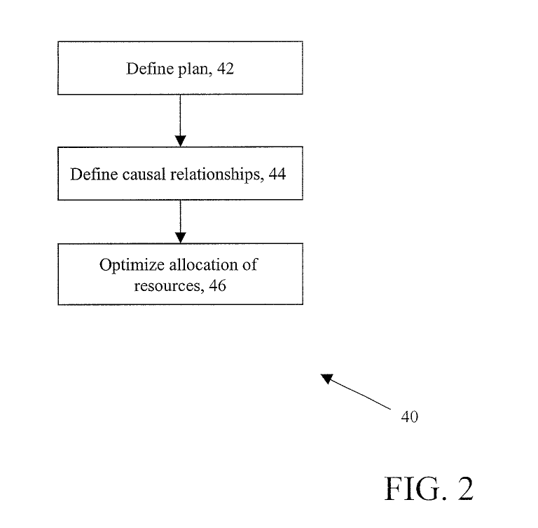

Referring to FIG. 2 an overall view of some of the functions performed by the marketing strategy software 32 is shown. The marketing strategy software includes a process 42 for defining a plan. The marketing strategy software 32 assists in defining 44 causal relationships among the inputs, outputs, and objectives of the plan. The marketing strategy software 32 allows 46 for optimization of allocation of resources among various marketing programs and plans.

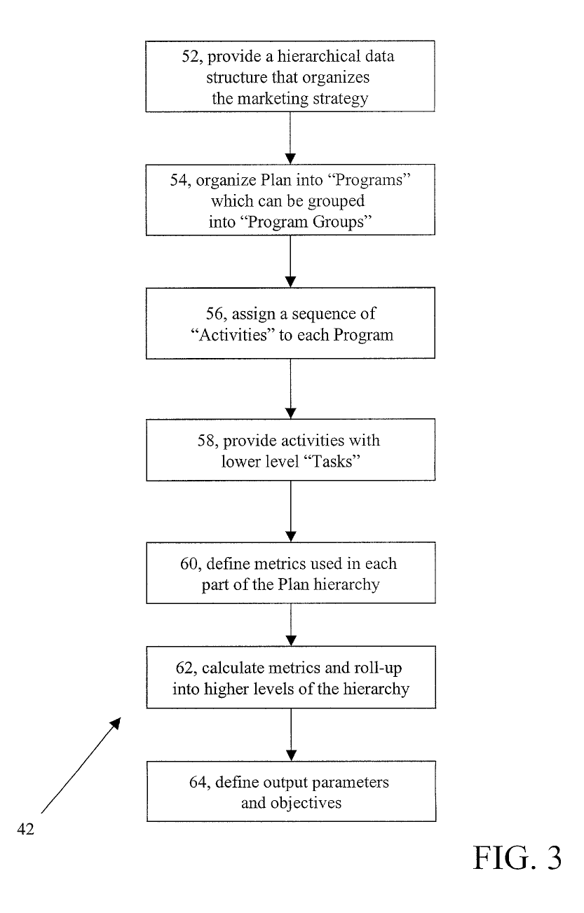

Referring to FIG. 3, one aspect of the marketing strategy software 32 is a process for defining 42 a plan. The marketing strategy software 32 provides a framework for defining 42 a marketing strategy, including all the various marketing programs that make up that strategy as well as all their constituent tasks. The process for defining 40 the marketing strategy within software 32 organizes planning hierarchically. The process 40 produces a hierarchical data structure 52 that organizes the marketing strategy, where at a top level is a “Plan”, as mentioned above. The marketing strategy software 32 allows organization of the Plan into “Programs” some or all of which can be grouped 54 together into “Program Groups”, as mentioned above. Each Program is assigned 56 a sequence of “Activities”, for example, (1) define objectives (2) determine audience (3) create creative piece (4) design newspaper ad (5) build model (6) execute campaign (7) place newspaper ad (8) communicate with mail shop (9) perform analysis (10) present results. Activities are provided 58 with lower level “Tasks”. For example, activity number (6) above (execute campaign) might include the following set of tasks: (a) perform the initial build of the campaign (b) get approval of counts (c) send test file to vendor (d) configure promotion history (e) schedule execution.

Part of the process 40 for defining a Plan includes the definition of resources 60 used in each part of the Plan hierarchy. The resources tracked include human resources (typically measured in man-hours), computing resources (typically measured in CPU cycles), time (measured by dates), and financial resources (e.g. dollars), and may also include other types of resources, such as inventory and so on.

The resources used at lower levels within the Plan hierarchy are rolled-up 62 into higher levels of the hierarchy. For example, the total budget for activity number (6) above would be the sum of the budgets for each of its constituent tasks (a) through (e). Other types of resources are rolled up in a similar manner.

Templates are embedded in the marketing software 32 to enable entry of metrics for the plan hierarchy. The metric templates are encapsulated in XML and provide the calculations on how individual metrics interrelate to each other. For example, expense equals the sum of all the expenses beneath it in the hierarchy, and cost per contact equals expense divided by the number of contacts and so forth. Standard templates can be provided with the software and a user can produce any number of additional templates or edit the templates to customize them. One way of editing the templates is to provide a graphical user interface, another way is to provide a text editor, e.g., an XML viewer. An illustrative example of templates as provided in XML can be of the form:

for metrics;

<Metric Name=“NumberOfContacts” Optimization=“Na”>

<DisplayName>Number of Contacts</DisplayNalne>

<Description>Number of Contacts</Description>

<Unit>#</Unit>

for equations to calculate a value

<Metric Name=“PercentageReached” Optimization=“Max”>

<DisplayName>Percentage Reached</DisplayName>

<Description>Percentage Reached</Description>

<Unit>%</Unit>

and to roll up values to higher levels of the hierarchy:

</MetricRef>

<MetricRef Name=“PercentageReached” Estimated=“Y” Input=“Compute” Rollup=“Formula”>

<Formula>(NumberOfContacts-NumberOfUnreachables)/NumberOfContacts</Formula>

The marketing strategy software 32 helps in determining an optimal allocation of resources among various marketing programs. The relative allocation of resources to each of the parts of a Plan provides input parameters to the Plan. Determining the most efficient and profitable allocation of resources is important to the ultimate success of the plan. The input parameters of the Plan include those budget values over which decision makers in an organization have control.

The process also defines 64 the output parameters and objectives of the Plan. Examples of typical outputs include counts from marketing campaigns such as the number contacted and number of responses, response rates, revenue figures, as well as statistics such as cost per lead or cost per opportunity, and so on. Objectives typically include maximizing profitability or return on investment, but may also include such goals as increased brand recognition, enhanced corporate image, customer satisfaction, and the like.

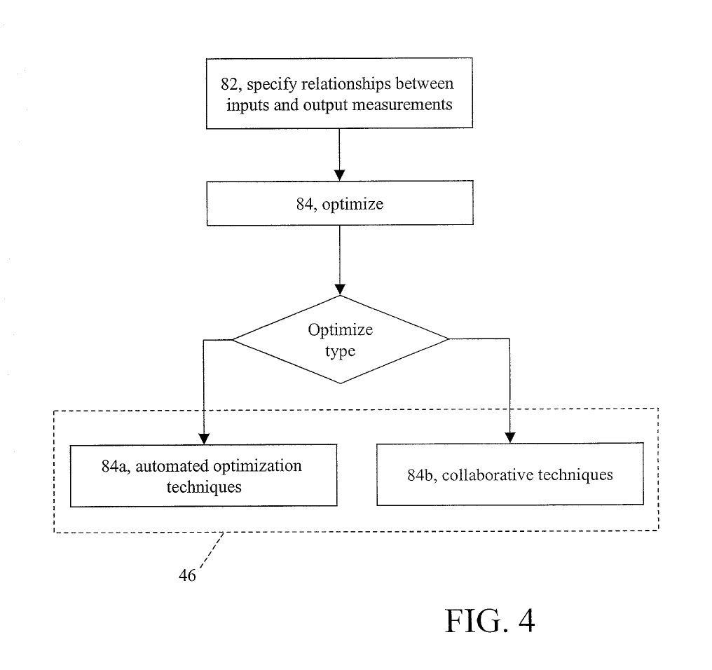

Referring to FIG. 4, the process 44 to define the causal relationships among the inputs, outputs, and objectives throughout the Plan hierarchy is shown. This process 44 typically involves the use of formulas. For example, the number of contacts would typically be a linear function of the budget for a particular marketing campaign. The relationship between metrics is often straightforward, as for example,

Response Rate=Number of Responses/Number of Contacts.

It is also useful in many cases to use more complicated methods of describing the relationships between the various Plan parameters. For example, response models or other types of models can be built using a variety of complex data modeling algorithms such as linear regression, logistic regression, neural networks, decision trees, and the like. Models can also be simulated if historical or other data is not available during the strategic planning process by making certain assumptions regarding the parametric form for the shape of the lift curve of the model to be simulated, the expected overall response rate, and the area under the lift curve.

Once the relationship between input measurements describing a marketing strategy and output measurements describing the outcome of the strategy have been specified 82, the marketing strategy software 32 helps to determine 84 the input measurements that will optimize 46 a given objective. There are two ways that optimization 46 can be accomplished, either by using automated optimization techniques 84a alone, or as part of a collaborative effort 84b with the user of the software.

Automated optimization techniques 84a that can be applied are numerous. The simplest method, known as “brute force” or exhaustive search, essentially evaluates all possible solutions to find the best one. This acceptable for situations with a small number of alternatives, but does not scale up well to larger problems. In more complex cases, there are a variety of optimization and search techniques that can be employed, such as Simulated Annealing, TABU search, evolutionary algorithms, and the like.

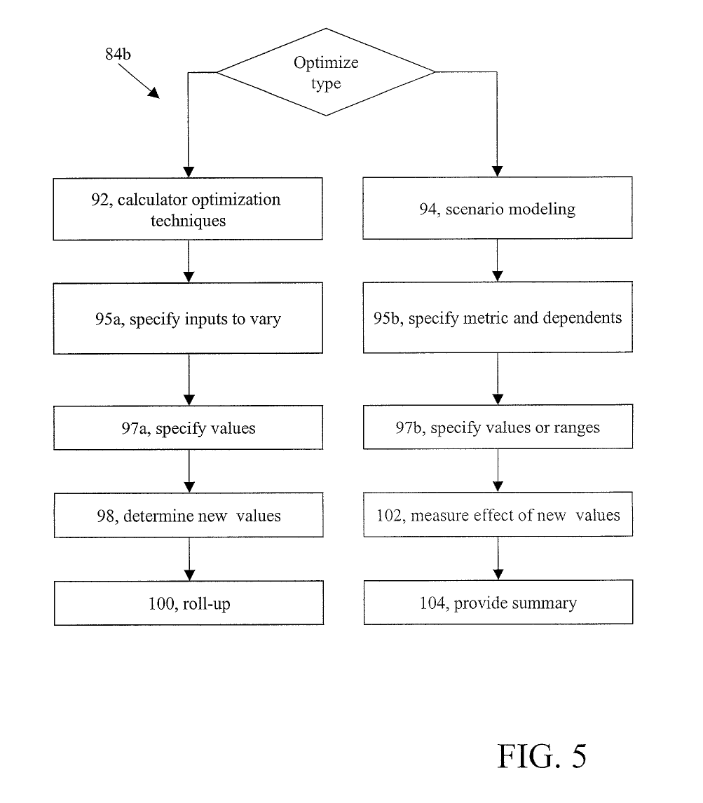

Referring to FIG. 5, the marketing strategy software 32 includes a collaborative optimization process 84b that can optimize plans or programs. Due to the complexity of many marketing strategies, the number of possible solutions to be considered may be vast. Therefore, an important capability offered by the marketing strategy software 32 is the ability for the user to collaborate in the optimization process 84b. Two examples of how this is facilitated are the interactive metric calculator 92 and the scenario-modeling wizard 94, either of which can be selected 90 by the user. In either instance the user would select 95a, 95b a subset of inputs to vary in the optimization process, and a set of values to be considered 97a, 97b for each of those inputs. This allows human expertise to be included in the optimization process, and reduces the necessary computation time. The optimize process 84b takes the input values entered and calculates new values for higher-level metrics. The optimize process 84b accesses the template to enter values and to have the values rolled up to the higher levels of the hierarchy

“Interactive Metric Calculator” 92 allows the user to analyze “what-if” type scenarios, by changing certain input values, and noting the resultant changes in the outputs and objective function. A user chooses a specific metric and the process 84b shows the current target roll up value and allows the user to edit the value. A user enters a new value and the process 84b shows all of the dependencies that are associated with the edited metric. Thus, the user can optimize a program or plan by entering new target values for certain metrics. The program calculates 98 new values of affected metrics and rolls up 100 the new values to higher-level metrics.

For example, a user might want to change revenue; the process 84b will determine that a change in revenue will provide a concomitant change in return on investment. The calculations that control the change in related metrics are defined in a metric template, which is represented in an XML template. The template is completely customizable.

In the “Scenario Modeling Wizard” 94 discrete values are entered to allow the user to optimize the plan or program by adjusting the values for different metrics. With the scenario modeling wizard method, a user can select a metric 95b and some of its dependents to vary, specifying 97b possible input values. In response, the marketing strategy software 32 measures 102 the effects of these changes on the target roll-up values of higher-level metrics. The optimize process 84b can automatically calculate all the permutations of the different possible value combinations and ranks results in an order of how well the results achieve an optimization of the specific metric. The wizard can provide 104 a complete summary of all possible value combinations and their effects on the “output” metric.

For example, a user can choose to optimize “return on investment” for a marketing plan. The scenario-modeling wizard shows all the different inputs that are associated with “return on investment” for a specific marketing plan. Several different metrics are used to calculate return on investment or use ROI, and to roll up results to higher levels of the hierarchy. For each metric used to determine ROI, a user can enter comma separated values or range of values with an increment. Alternatively, a user can enter constraints. Instead of entering a discrete number of values, a user can specify a value to be less than, greater than equal to, etc. a particular amount, with an increment.

The process 84b can model all of the scenarios using all the possible permutations that satisfy specified constraints or actually produce different combinatorial expressions of the different values that were specified.

The process 84b produces a report that shows the values of the metrics, which achieve the optimized value, and ranks the values. The process 84b allows a user to automatically filter the different permutations based on a criterion or criteria, e.g., all results where the expense was less than $50,000. The process 84b would redisplay the list still sorted but only having results that met the specified criteria.

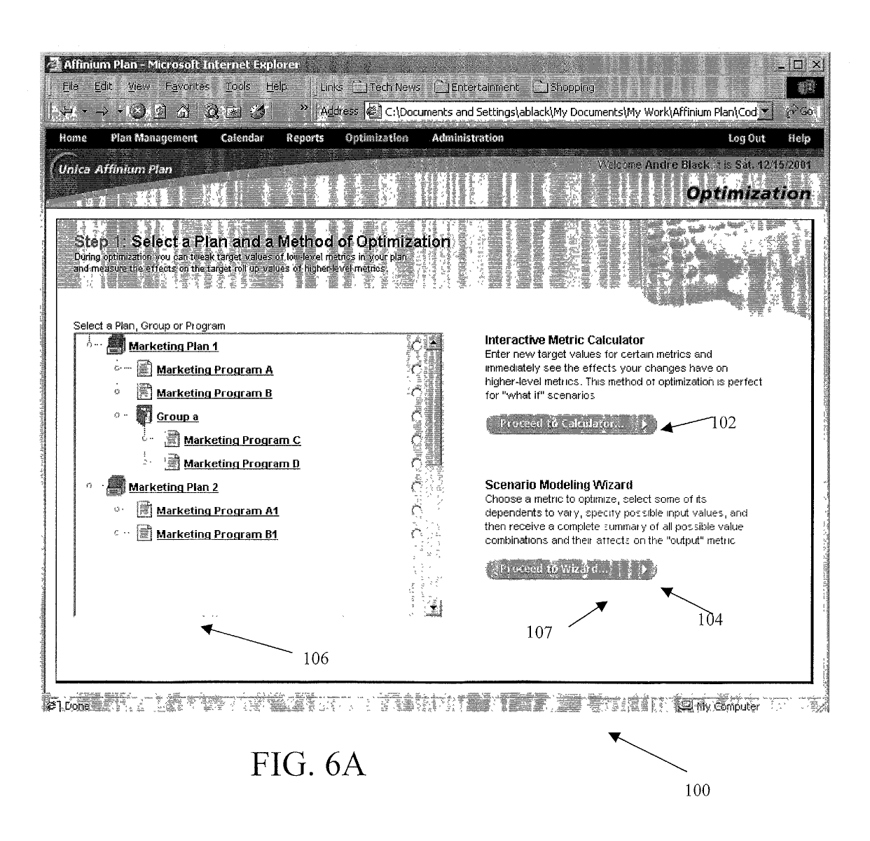

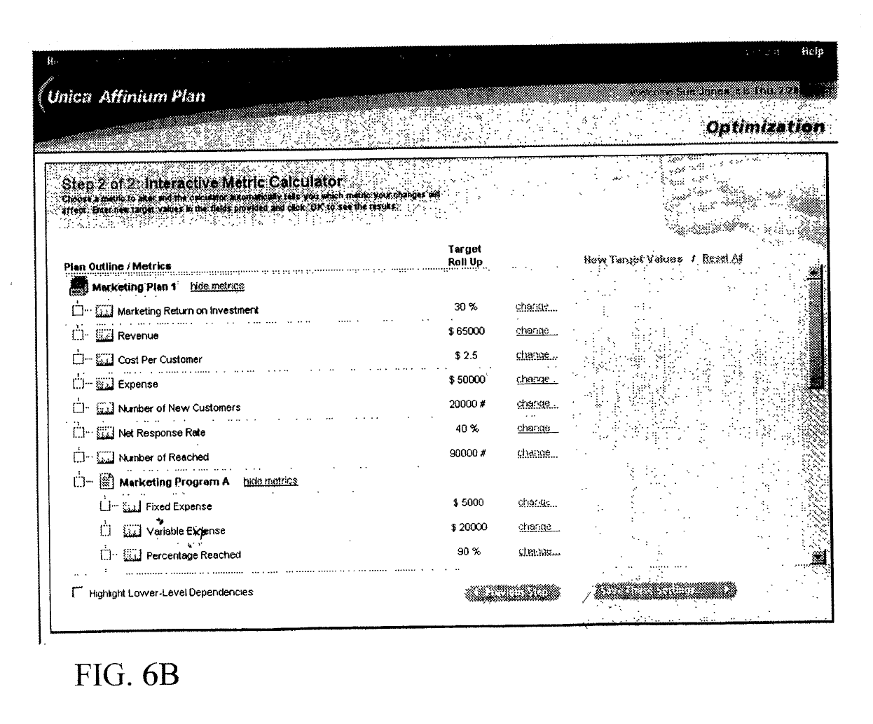

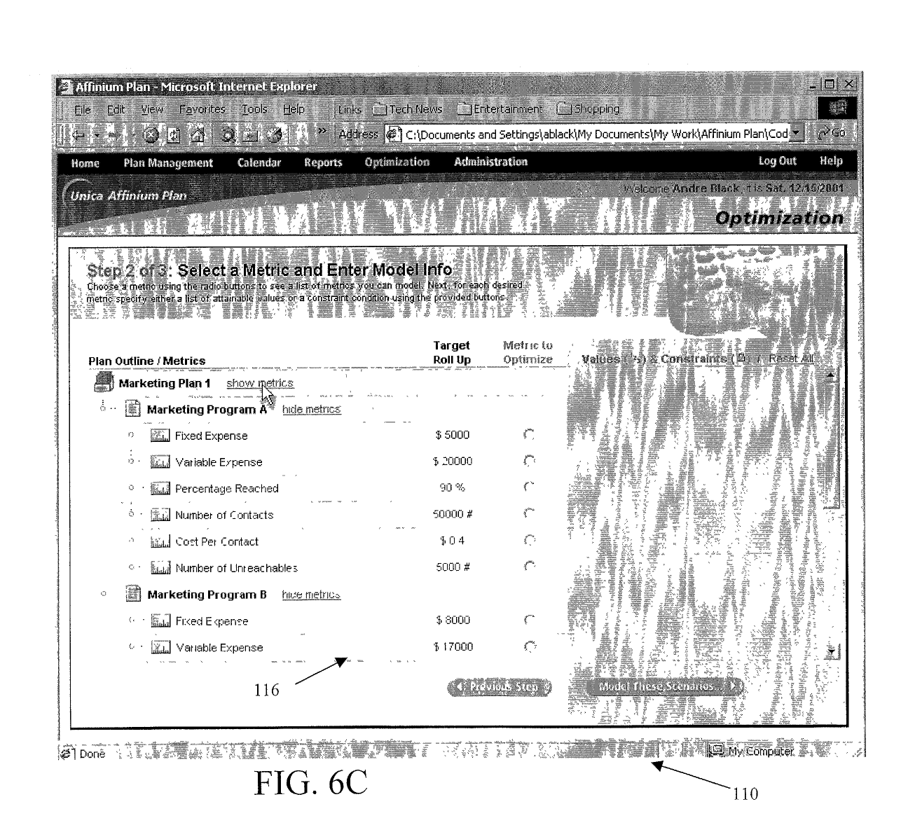

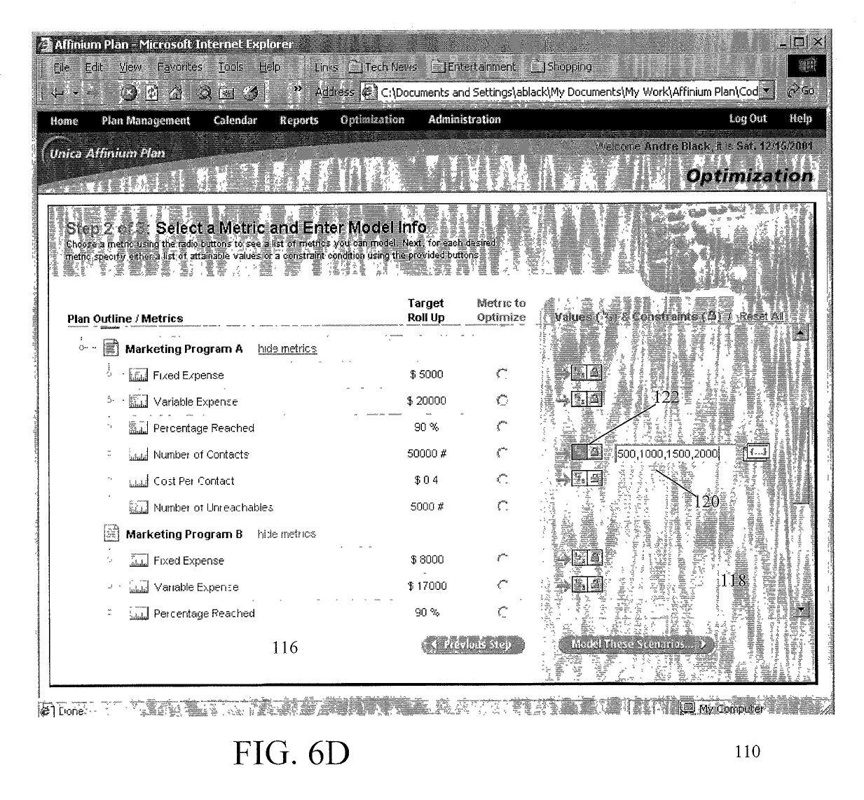

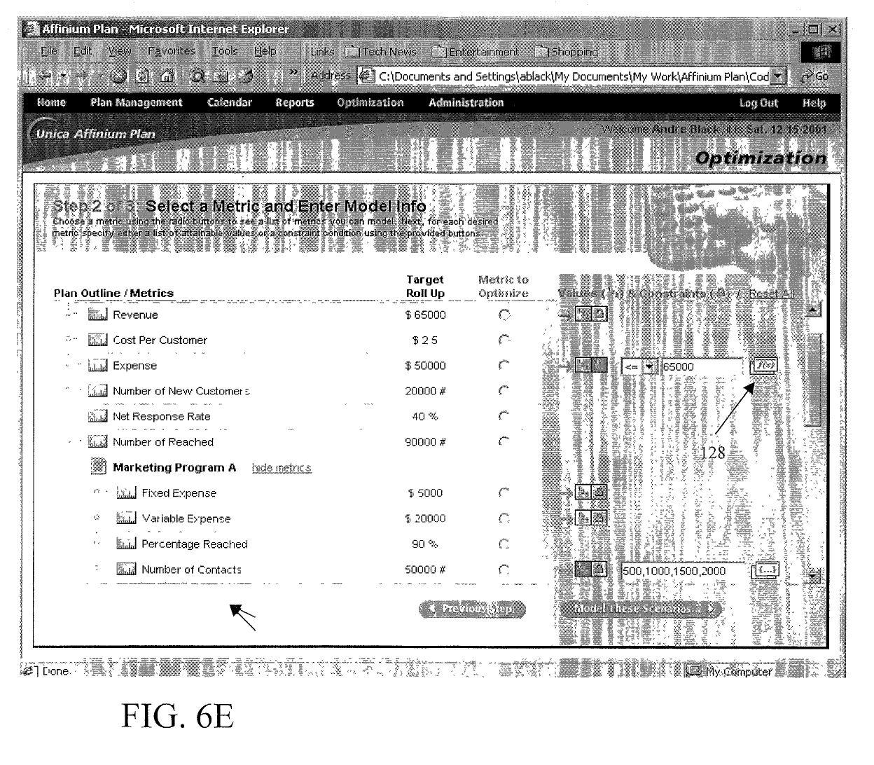

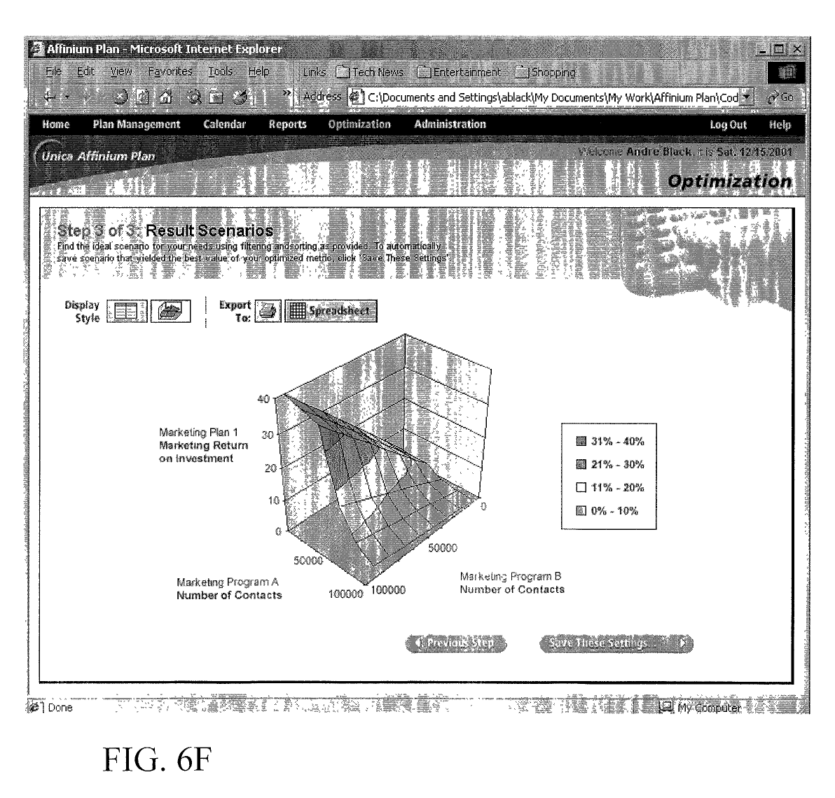

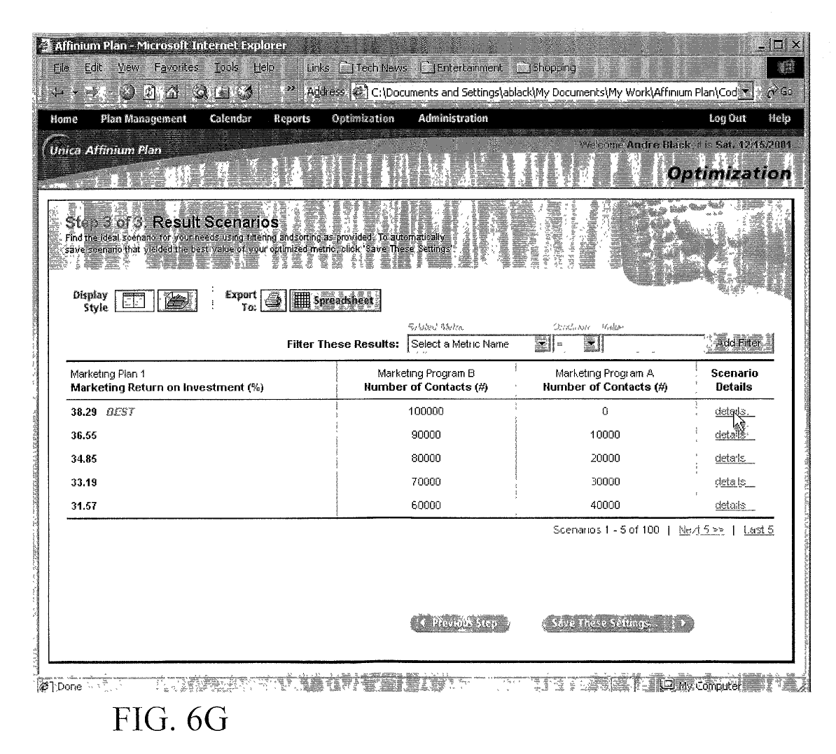

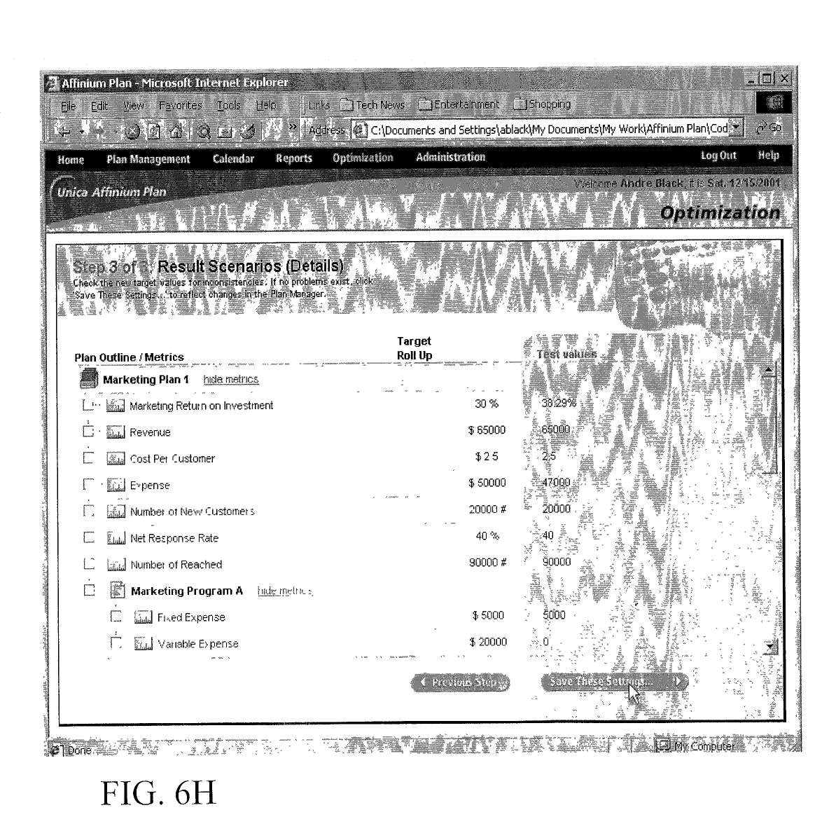

FIGS. 6A-6D depict aspects of a graphical user interface (here implemented in a web browser window) that can be used in the user-defined optimization view.

FIG. 6A shows a first window 100 of the optimization view, which allows a user to work in the optimize view by using the interactive metric calculator 102 and a scenario modeling wizard 104. The Optimization view allows a user to optimize metrics for a Plan or Program. A frame 106 is provided within window 100, which depicts the hierarchical organization of plans and programs. The window 100 also includes a column that has target roll up values, which are calculated by the marketing strategy software 32.

To use the Interactive Metric Calculator a user accesses the Optimize view window 100 and clicks the corresponding checkbox in the left pane 106 to select the component to optimize. In the right pane 107, the user then clicks “Interactive Metric Calculator” 102 to select the Interactive Metric Calculator. In response the adjust values screen of the Interactive Metric Calculator appears, as shown in FIG. 6B, which displays all of the factors that roll up into the metric(s) of the component selected. The user can adjust the values of parameters in the optimization formula by clicking change next to a parameter to adjust its value through an editable text box that appears in the New Target Values column. The window will display its current target value.

A user can also click Hide Metrics to remove from view the metric factors for any component that the user does not want to view, and Show Metrics to reveal the metric factors for a component that the user desires to view. A user can click Highlight Lower-Level Dependencies to see which parameters are dependent on the one selected. An arrow or other indicia can be used to indicate which parameters depend on the value selected. Thereafter the value can be edited as desired to adjust the optimization. The new optimization values are displayed in the Target Roll Up column. These values can be saved for later use.

FIGS. 6C-6E show window 110 where a user can optimize one or more metrics for a plan or program. Window 110 has a frame 116 where the hierarchy of plans and programs is expanded to show metrics. It has a control box (not numbered) next to each metric to select the metric and as shown in FIGS. 6C-6D another frame 118 is opened to reveal edit boxes 120 where metric values can be added to modify underlying model information for the selected plan or program. The user would select a Metric and enter model information. The window displays all of the factors that roll up into the metrics of the component selected. The optimization tool buttons appears where a user can enter a list of comma-separated values 122 for the metric or enter a constraint condition or formula 124 for the metric.

In FIG. 6C, comma-separated values button 122 is selected to enable discrete values to be entered into the edit box 120. The user optimizes the plan or program by adjusting the values for different metrics. In response the marketing strategy software 32 measures the effects of these changes on the target roll-up values of higher-level metrics. With this Scenario Modeling Wizard method, a user can select a metric and some of its dependents to vary, specify possible input values, and receive a complete summary of all possible value combinations and their affects on the “output” metric.

As shown in FIG. 6E, the Constraint button becomes highlighted 124, a text box appears, and a Formula Generator button 128 is displayed, as shown. The Formula Generator Button 128 if selected allows a Formula Generator window to appear. The Formula Generator Window allows a user to enter value(s) into an equation to use in constraining the optimization scenarios. When finished entering values a user can save and cause the formula generator window to close and the constraint to be entered into the plan formula generator.

Referring to FIGS. 6F-6H a user can select details FIG. 6F to view more information about a particular scenario. The user can select a display style or export format from the Display Style and Export to buttons that appear in FIG. 6G, which also depicts a graph of ROI for 2 programs with the number of contacts being varied in each program. Display types can include a pie chart, a bar chart or a table and so forth

The software 32 generates scenarios based on the first, e.g., twenty values of the series generated from the values entered and displays a list of these scenarios.

FIG. 6H depicts filtered result scenarios. A user can use a filter feature to filter scenario results by selecting which scenario modeling results to view. To filter scenario results a user uses the filter feature to select which scenario modeling results to view. The user can select a metric from a related metric drop-down list, select a value from a condition drop-down list and enter a numeric value in the Value text field. The user can add the filter to filter the results. The result scenario window FIG. 6H is refreshed and displays the filtered results list.

Additional features of the marketing strategy software 32 include the capability to filter out possible solutions that do not satisfy certain constraints, e.g., where an insufficient number of responses were obtained. In addition, the marketing strategy software 32 allows possible solutions to be ordered by their values over any combination of the input measurements, output measurements, or objectives.

Accordingly, the marketing strategy software 32 provides the ability to perform sensitivity analysis, which measures how changes in one variable affect another. Measuring the sensitivity of the objective or another output variable to changes in each of the input variables may provide clues as to the best-input variables to change in order to bring about some desired result. Sensitivity analysis is performed by taking the partial derivatives of the output variables with respect to the input variables. With linear relationships, this produces constants, but for non-linear relationships, the derivatives will vary depending on the values of the inputs. Sensitivity analysis can help the user of the marketing strategy software 32 by suggesting appropriate input variables to modify in any “what-if” type scenarios, as mentioned.

The marketing strategy software 32 also allows the inputs to be specified as probability distributions, which is useful for example in cases where some of the input values are not known with certainty. Input distributions can be specified as independent parametric distributions, for example as Gaussian with given mean and variance, or exponential with given mean, or as more complex joint density functions. Several techniques can be used to generate the resulting output distributions. In the case of independent parametric distributions and simple formulas for deriving the outputs from the inputs, the resulting distributions may be found analytically. In more complex cases, other techniques can be used, such as Monte Carlo simulations. Once the output distribution has been found, statistics of interest related to the output distributions or the objective can be calculated, including but not limited to the mean, variance, minimum, maximum, and confidence intervals.

Other embodiments are within the scope of the following claims. For example, although this can be used to model marketing campaigns, it can be used for any type of planning project where entities and activities can be organized and optimized. For example, planning trade shows, marketing campaigns, competitive analysis, project engineering, etc. can all benefit. What would be done would be to modify names of groups, specific activities and produce new metrics and relationships between metrics and activities all built into templates.

What is claimed is:

1. A method of marketing strategy optimization comprises:
specifying a causal relationship between input measurements describing a marketing strategy and output measurements describing the outcome of the strategy, and
determining input measurements that optimize a given objective.

2. The method of claim 1 wherein at least one value is specified for at least one input, and combinations of these values are evaluated with respect to the objective.

3. The method of claim 2 wherein some of the combinations are filtered out based on constraints on the output measurements or on the objective.

4. The method of claim 2 wherein the combinations are ordered by the input measurements, the output measurements, and/or the objective.

5. The method of claim 1 wherein a sensitivity analysis is performed to determine the most important inputs to optimize.

6. The method of claim 1 wherein inputs whose measurements are unkown can be specified as a probability distribution.

7. The method of claim 6 wherein output measurements and objective are also characterized by a probability distribution.

8. The method of claim 7 wherein output measurements and objective are characterized by at least one mathematical statistic.

9. The method of claim 8 wherein at least one mathematical statistic is selected from a mean, a variance, a minimum, a maximum, and a confidence interval of the output measurements.

10. The method of claim 1 wherein the optimization occurs across multiple inputs.

11. A method of marketing strategy optimization comprises:
hierarchically organizing a marketing strategy by plans and programs with each of plans and programs having input metrics having a causal relationship to output measurements that describe the outcome of the strategy; and
determining input measurements that optimize a given output for the strategy.

12. The method of claim 11 wherein at least one value is specified for at least one input, and combinations of these values are evaluated with respect to the objective.

13. The method of claim 12 wherein some of the combinations are filtered out based on constraints on the output measurements or on the objective.

14. The method of claim 12 wherein the combinations are ordered by the input measurements, the output measurements, and/or the objective.

15. The method of claim 11 wherein a sensitivity analysis is performed to determine the most important inputs to optimize.

16. The method of claim 11 wherein inputs whose measurements are unkown can be specified as a probability distribution.

17. The method of claim 16 wherein output measurements and objective are also characterized by a probability distribution.

18. The method of claim 17 wherein output measurements and objective are characterized by at least one mathematical statistic.

19. The method of claim 18 wherein at least one mathematical statistic is selected from a mean, a variance, a minimum, a maximum, and a confidence interval of the output measurements.

20. The method of claim 1 wherein the optimization occurs across multiple inputs.

21. A graphical user interface for optimization view in a market strategy optimization program comprises:
a first region which depicts a hierarchical organization of plans and programs associated with the market strategy;
a second region having a column that has target roll up values that are calculated by a marketing strategy optimization software; and
a third region having edit window to enter values for metrics when the hierarchy of plans and programs is expanded to show metrics associated with the plans and programs.

22. The interface of claim 21 wherein the view is as a web browser window.

23. The interface of claim 21 wherein the third region has a control box that when selected allows a user to enter a list of comma-separated values.

24. The interface of claim 21 wherein the third region has a control box that when selected allows a user to enter a constraint condition or formula for the metric.

25. The interface of claim 21 wherein the third region has a control box that when selected allows a user to enter a constraint condition, and further includes a control box that when selected launches a formula window to allow a user to construct a formula for the metric.

26. A computer program product for marketing strategy optimization comprises instructions to cause a computer to:
hierarchically organize a marketing strategy by plans and programs with each of plans and programs having input metrics having a causal relationship to output measurements that describe the outcome of the strategy; and
determine input measurements that optimize a given output for the strategy.

27. The computer program product of claim 26 further comprising instructions to:
perform a sensitivity analysis on data representing the marketing strategy to determine the most important inputs to optimize.
